(19) United States
(12) Patent Application Publication
(10) Pub. No.: US 2019/0063675 A1
(43) Pub. Date: Feb. 28, 2019

(54) CORK KEEPER

(71) Applicants: Nick Savva, Wayne, NJ (US); Rocco Silano, Wayne, NJ (US)

(72) Inventors: Nick Savva, Wayne, NJ (US); Rocco Silano, Wayne, NJ (US)

(21) Appl. No.: 16/117,257

(22) Filed: Aug. 30, 2018

Related U.S. Application Data
(60) Provisional application No. 62/552,549, filed on Aug. 31, 2017.

(51) Int. Cl. F16M 13/02; F16B 47/00

(52) U.S. Cl. CPC F16M 13/022; F16B 47/00

(57) ABSTRACT

A holder or keeper for a cork or stopper of a bottle is described. The holder or keeper may utilize a suction cup to be selectively attached to the bottle when the cork or stopper is not in use. Alternatively, the suction cup may be adhered to the bottle at all times. The holder or keeper has a hook which is configured to retain an inserted cork or stopper.

### CLAIM OF PRIORITY

This application claims the priority benefit of U.S. Provisional Patent Application No. 62/552,549, filed on Aug. 31, 2017, the contents of which are hereby incorporated by reference into this application.

### FIELD OF THE EMBODIMENTS

This field of the embodiments of the present invention relate to a holder or keeper for a cork or stopper of a bottle when the cork or stopper is not positioned in an opening of the bottle. The holder or keeper may be coupled to the bottle or other structure such that the cork or stopper is not lost when removed from the bottle opening.

### BACKGROUND OF THE EMBODIMENTS

Corks have been used for centuries to seal a wine bottle. Such corks may be made from a single piece of cork or a number of pieces of cork. Corks are popular in the wine industry due to the ability to allow some transfer of oxygen between the bottle and surrounding atmosphere, as well as the compressibility of the cork. In some instances, corks may be able to be reinserted into a bottle once removed thereby allowing the bottle to be resealed. In addition, current trends have resulted in people keeping corks for sentimental reasons or for decor. Accordingly, there is a need for an apparatus that will keep a cork, when not inserted in a bottle, in a convenient location for reuse or for keeping for later. Review of related technology:

U.S. Pat. No. 859,716 pertains to a cork holder for a bottle to provide a convenient place for the cork of a bottle after the same has been removed for the purpose of emptying any portion of the contents of the bottle.

U.S. Pat. No. 351,680 pertains to an attachment for stoppers or corks of bottles for securing or attaching the cork or stopper to the bottle when removed from its mouth or neck, so as to avoid losing or mislaying a cork or stopper during pouring, filling, or other operation.

Canadian Patent 2,092,736 pertains to a device for holding the cork of a bottle adjacent to the neck of that bottle, in particular but not exclusively a bottle of wine or champagne.

French Patent 2,746,375 pertains to a device for retaining its stopper and thus preventing the wine from flowing out comprising a large ring, place onto the wine bottle neck, provided with foam on its internal surface and a smaller open ring, attached to the large ring, enabling the plug to be clopped to the bottle.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present application generally provides for a cork keeper apparatus (cork holder) having an attachment mechanism configured to selectively retain the cork keeper apparatus to a surface. The cork keeper apparatus further includes a hook member, The hook member may retain a cork and/or a stopper. The hook member may be connected to the attachment mechanism.

In another embodiment of the present invention a cork keeper system is described. The cork keeper system may include a suction cup configured to selectively retain the cork keeper system to a surface. The suction cup may include a cup member, a spacer, and a top portion. The cork keeper system may also include a hook member connected to the suction cup. The hook member may be configured to selectively retain a cork. The hook member may include a base member connected to the top portion of the suction cup. An initial curved shaft may be attached to the base member. An initial opening may be placed on the initial curved shaft. An initial flared tip may be located at an end of the initial curved shaft.

In yet another alternative embodiment, a method of retaining a cork is described. The method may include attaching a cup member of a suction cup to an outer surface of a wine bottle. The cork of the wine bottle may be inserted to a hook member attached to the suction cup. An identifying apparatus may also be inserted into an opening on the hook member.

In general, the present invention succeeds in conferring the following, and others not mentioned, benefits and objectives.

It is an object of the present invention to provide an apparatus that is lightweight and easy to use.

It is an object of the present invention to provide an apparatus that may be coupled to a variety of objects.

It is an object of the present invention to provide an apparatus that is configured to hold at least one cork or stopper.

It is an object of the present invention to provide an apparatus that is decorative while in use and not in use.

It is an object of the present invention to provide an apparatus that includes an opening which may be used to attach a decorative adornment, such a licensed logo, image, design, character, letter, etc., to the apparatus.

It is an object of the present invention to provide an apparatus that is flexible and resilient.

It is an object of the present invention to provide an apparatus that may be attached to a wine or other bottle.

### BRIEF DESCRIPTION OF THE DRAWINGS

FIG. 1 shows a side view of an embodiment of the present invention.

FIG. 2 shows a perspective view of an embodiment of the present invention.

FIG. 3 shows an alternative embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

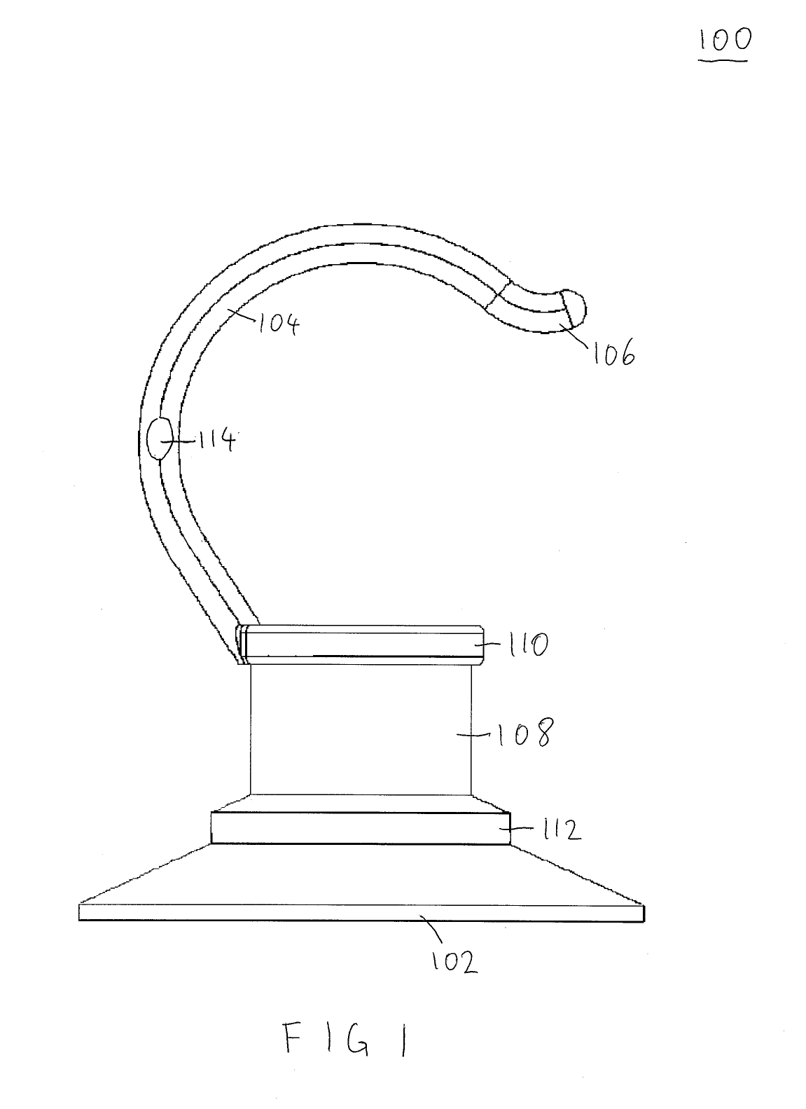

Referring now to FIG. 1, the cork keeper 100 (or holder) includes an attachment mechanism 102 and a hook member 104. The attachment mechanism 102 may further include a top portion 112 and a spacer 108. The hook member 104 may further include a base member 110, a curved shaft, an opening 114, and a flared tip 106.

In use, the attachment mechanism 102 is coupled to or otherwise affixed to a secondary object (bottle, wall, cabinet, etc.) thereby allowing a cork or stopper (not shown) to be selectively retained by the hook member 104. In a preferred embodiment, the cork keeper 100 is coupled to a wine bottle during use of the bottle and wherein the cork is not inserted into the neck of the bottle.

The attachment mechanism 102 may be a number of different mechanisms including adhesive and suction based mechanisms. In some embodiments, the attachment mechanism 102 causes the cork keeper 100 to be permanently affixed (removal would destroy secondary object or cork keeper) to the secondary object, whereas it may be preferable for the cork keeper 100 to be detachable from the secondary object. In a preferred embodiment, the attachment mechanism 102 is a suction cup.

The attachment mechanism 102 may include the top portion 112 and the spacer 108. The top portion 112 may have a shape (such as tapered) and a structure that encloses an attachable component of the attachment mechanism 102 (such as a suction member). The top portion 112 may also include a shape and structure that connects to the spacer 108. In some embodiments, the top portion 112 and the spacer 108 are affixed to one another forming a unitary structure. In other embodiments, the top portion 112 and the spacer 108 may be separable from the attachment mechanism 102. Detachable components may allow for the attachment mechanism 102 that is modular and alterable for a particular function or appearance.

The hook member 104 is coupled to the attachment mechanism 102 by way of the base member 110. In some embodiments, the base member 110 is separable from the attachment mechanism 102 thereby allowing different hook member(s) to be used with the attachment mechanism 102. For example, the hook member 104 may have a structure allowing it to retain one cork or stopper. However, alternative structures may also be used allowing the hook member 104 to retain more than one cork or stopper simultaneously. For example, the hook member 104 may have an initial curved shaft and a secondary curved shaft attached the base member 110. The initial and secondary curved shafts may be placed in opposing directions. Thus, a user can change the hook member 104 based on demand to suit cork attachment demand(s).

The flared tip 106 is configured to allow the cork or the stopper to be retained by the hook member 104. A surface of the flared tip may be covered with a nonslip material. The nonslip material may prevent the cork from excess movement while within the hook member 104. The cork or stopper may be introduced via the opening formed between the base member 110 and the flared tip 106. Furthermore, a user may be allowed to gently manipulate the flared tip 106 away from the base member 110 to remove the cork or stopper from the cork keeper 100.

Furthermore, as shown in FIG. 1, the cork keeper 100 may have the opening 114 on the hook member 104. An example of the opening 114 may include a hole on the hook member 104. The opening may be placed in a variety of positions on the curved shaft of the hook member 104 including on the flared tip 106, a middle position, and/or an end position near the base member 110. The opening 114 may be used to attach various ornamentation, identifiers, etc. to the cork keeper 100. For example, the opening 114 may allow an identifying apparatus to be attached. The identifying apparatus may identify a user of the cork keeper 100. For example, wineries, hotels, restaurants, corporations, or sports teams may have a unique object (as the identifying apparatus) that may be attached to the opening 114. The unique object may identify a source of origin and provide visibility or desirability in relation to the cork keeper 100.

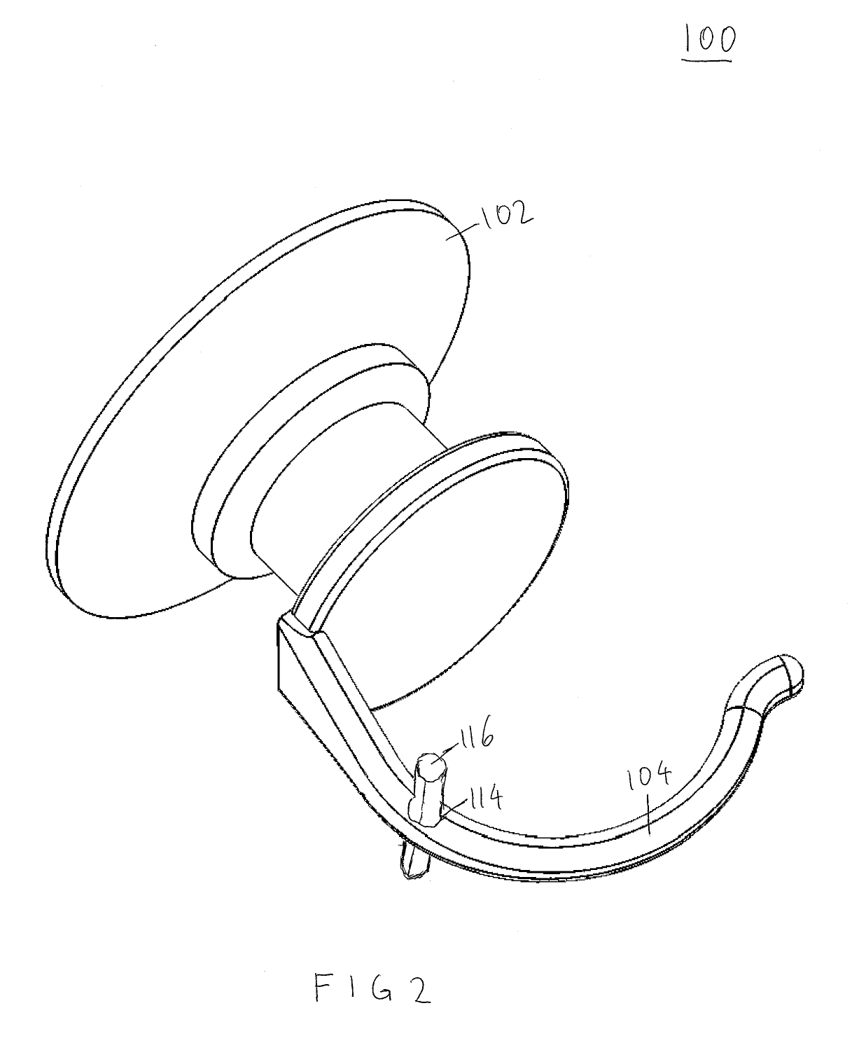

FIG. 2 shows a perspective view of the cork keeper 100. The cork keeper 100 may include the attachment mechanism 102. The attachment mechanism 102 may include a suction cup to selectively (or permanently) attach the cork keeper 100 to a surface, such as an outer surface of a wine bottle (or a wall, among others). The cork keeper 100 may also include the hook member 104 that is connected to the attachment mechanism 102. The hook member 104 may include a curved shaft to enclose and retain the cork (when inserted into the hook member 104).

The hook member 104 may include the opening 114 to further insert or connect objects to the hook member 104. In an example scenario, an identifying apparatus 116 may be inserted into the opening 114 to differentiate the cork keeper 100 from nearby cork keeper(s). An example of the identifying apparatus 116 may include a cylinder with a solid color, a texture, and/or a pattern, among other schemes to help a user differentiate the cork keeper 100 from other cork keeper(s).

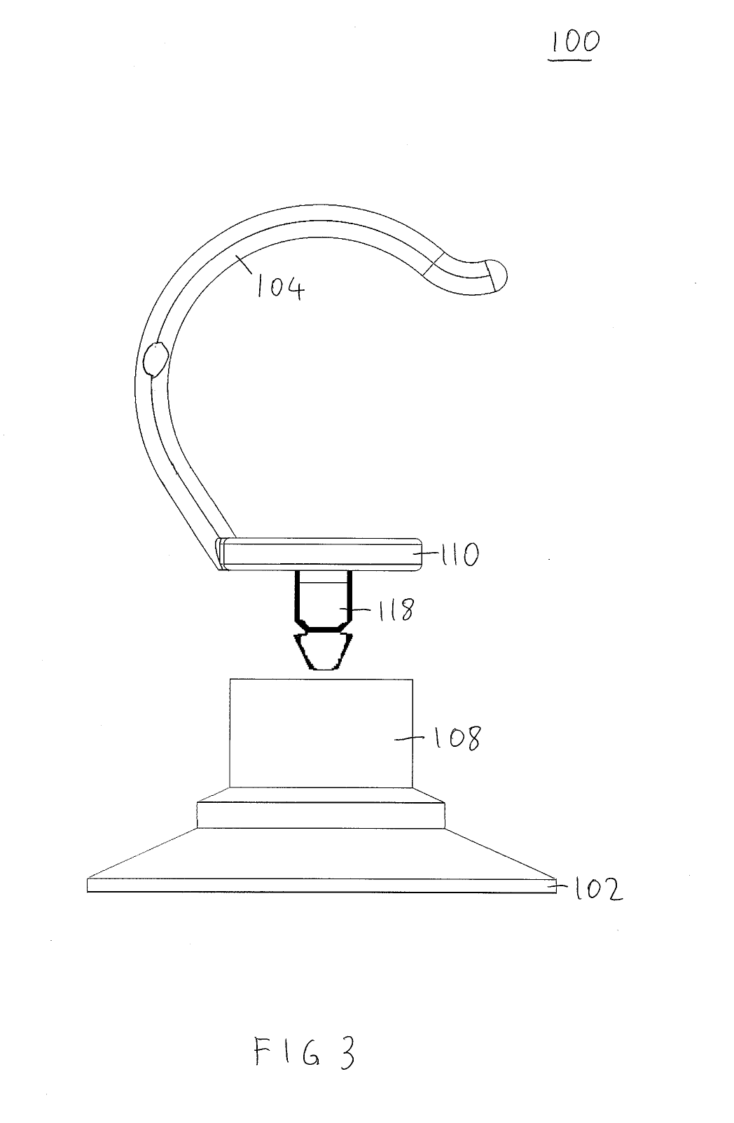

FIG. 3 shows an alternative embodiment of the cork keeper 100. The cork keeper 100 may include the attachment mechanism 102 and a hook member 104. The attachment mechanism may include the spacer 108. The hook member 104 may include a curved shaft with an opening to accept an identifying apparatus. The curved shaft may be connected to the base member 110. The base member 110 may further be connected to an attachment adapter 118. The curved shaft, the base member 110, and the attachment adapter 118 may all be components of a unified structure of the hook member 104. Alternatively, the components of the hook member 104 may be detachable.

The hook member 104 may be connected to the attachment mechanism 102 by inserting the attachment adapter 118 to a complementary opening in the spacer 108 of the attachment mechanism 104. The attachment adapter 118 may be connected to the spacer 108 using an amount of force in a direction towards the spacer 108. The applied force may allow the two components to connect and remain attached. A different (or same) amount of force may be applied in an opposing direction to the hook member 104 to detach the attachment adapter 118 from the spacer 108.

In an alternative example, a surface of the curved shaft of the hook member 104 may be covered in a nonslip material. The nonslip material may prevent an inserted cork from excess motion or slippage. For example, a cork may be inserted into the curved shaft of the hook member 104. The non-slip material on the surface of the curved shaft may prevent the inserted cork from slipping out until a sufficient force is applied to push the inserted cork out of the hook member 104.

In another alternative scenario, the base member 110 and the spacer 108 may have treads to connect each component. For example, the hook member 104 may be connected to the attachment mechanism 102 by screwing the base member 110 to the spacer 108. Additionally, the attachment mechanism 102 may be connected to an external surface using a detachable component such as a suction cup. The attachment mechanism 102 may also be permanently connected to the external surface with an adhesive or other mechanism.

A method of retaining a cork is also described. The method may include attaching a cup member of a suction cup to an outer surface of a wine bottle. The cork of the wine bottle may be inserted to a hook member attached to the suction cup. An identifying apparatus may also be inserted into an opening on the hook member.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A cork keeper apparatus comprising:
an attachment mechanism configured to selectively retain the cork keeper apparatus to a first surface; and
a hook member configured to selectively retain a cork or a stopper, wherein the hook member is coupled to the attachment mechanism.

2. The apparatus of claim 1, wherein the hook member includes a base member and an attachment adapter coupled to the base member.

3. The apparatus of claim 2, wherein the attachment adapter is inserted into the attachment mechanism to connect the hook member to the attachment mechanism.

4. The apparatus of claim 2, wherein the hook member is detachable from the attachment mechanism.

5. The apparatus of claim 1, wherein the hook member includes a flared tip.

6. The apparatus of claim 5, wherein a surface of the flared tip comprises a nonslip material.

7. The apparatus of claim 1, wherein the hook member includes a curved shaft configured to enclose the cork or the stopper.

8. The apparatus of claim 7, wherein the curved shaft is attached to a base member, and wherein the base member is coupled to the attachment mechanism.

9. The apparatus of claim 1 wherein the attachment mechanism further includes a top portion and a spacer.

10. The apparatus of claim 1 wherein the attachment mechanism is a suction cup.

11. The apparatus of claim 1 wherein the hook member further includes an opening.

12. The apparatus of claim 11, wherein the opening is one from a set of: a circular opening, an oval opening, and a square opening.

13. A cork keeper system comprising:
a suction cup configured to selectively retain the holder system to a surface, wherein the suction cup comprises a cup member, a spacer, and a top portion; and
a hook member coupled to the suction cup, wherein the hook member is configured to selectively retain a cork, and wherein the hook member includes
a base member coupled to the top portion of the suction cup,
an initial curved shaft attached to the base member,
an initial opening placed on the initial curved shaft, and
an initial flared tip located at an end of the initial curved shaft.

14. The system of claim 13, further comprising an identification apparatus inserted into the initial opening.

15. The system of claim 13, wherein the hook member further includes
a second curved shaft attached to the base member,
a second opening placed on the second curved shaft, and
a second flared tip located at the end of the second curved shaft.

16. The system of claim 14, wherein the initial curved shaft and the second curved shaft are positioned to face opposing directions.

17. A method of retaining a cork, the method comprising:
attaching a cup member of a suction cup to an outer surface of a wine bottle;
inserting a cork of the wine bottle to a hook member attached to the suction cup; and
inserting an identifying apparatus into an opening on the hook member.
